(19) United States
(12) Patent Application Publication
(10) Pub. No.: US 2025/0055226 A1
(43) Pub. Date: Feb. 13, 2025

(54) ELECTRICAL-CONNECTOR-EQUIPPED CABLE

(71) Applicant: Sumitomo Electric Industries, Ltd., Osaka-shi (JP)

(72) Inventors: Tatsuo MATSUDA, Kanuma-shi (JP); Chiaki KOJIMA, Kanuma-shi (JP); Yasunori ASANO, Osaka-shi (JP); Toshiaki KAKII, Osaka-shi (JP)

(73) Assignee: Sumitomo Electric Industries, Ltd., Osaka-shi (JP)

(21) Appl. No.: 18/783,557

(22) Filed: Jul. 25, 2024

(30) Foreign Application Priority Data
Aug. 10, 2023 (JP) 2023-130886

(51) Int. Cl. H01R 13/6477; H01R 24/20; H01R 24/60; H01R 25/00

(52) U.S. Cl. CPC H01R 13/6477; H01R 24/20; H01R 24/60; H01R 25/003

(57) ABSTRACT

An electrical-connector-equipped cable includes a ferrule including a front end surface and an insertion hole opened in the front end surface, and a flat cable including a plurality of conductors arranged side by side and an insulating covering collectively covering the plurality of conductors. Each of the plurality of conductors includes a front end region, the front end region being inserted into the insertion hole in such a manner as to be exposed from the covering so that the front end surface of the conductor is exposed from the front end surface of the ferrule. The ferrule includes a dielectric constant adjusting hole formed at a position in the vicinity of the insertion hole in the front end surface and configured to adjust a dielectric constant of the vicinity of the insertion hole.

### CROSS REFERENCE TO RELATED APPLICATIONS

The present application claims priority based on Japanese Patent Application No. 2023-130886, filed on Aug. 10, 2023, and the entire contents of the Japanese patent application are incorporated herein by reference.

### TECHNICAL FIELD

The present disclosure relates to an electrical-connector-equipped cable.

### BACKGROUND

A cable having a plurality of conductors and a covering are known (see, for example, WO 2019/208091). In this cable, a portion of the conductor is exposed from the covering, and an electric conductor is electrically connected to a substantially central position of the exposed portion.

### SUMMARY

An electrical-connector-equipped cable of the present disclosure includes a ferrule including a front end surface and an insertion hole opened in the front end surface, and a flat cable including a plurality of conductors arranged side by side and an insulating covering collectively covering the plurality of conductors. Each of the plurality of conductors includes a front end region, the front end region being inserted into the insertion hole in such a manner as to be exposed from the covering. The ferrule includes a dielectric constant adjusting hole formed at a position in the vicinity of the insertion hole in the front end surface and is configured to adjust a dielectric constant of the vicinity of the insertion hole.

### BRIEF DESCRIPTION OF THE DRAWINGS

FIG. 1 is a front view of an electrical-connector-equipped cable according to an embodiment.

FIG. 2 is a cross-sectional view of the electrical-connector-equipped cable taken along the line II-II shown in FIG. 1.

FIG. 3 is a cross-sectional view of a portion of the electrical-connector-equipped cable taken along the line III-III shown in FIG. 2.

FIG. 4 is a cross-sectional view of a portion of the electrical-connector-equipped cable taken along the line IV-IV shown in FIG. 2.

FIG. 5 is a cross-sectional view of a portion of the electrical-connector-equipped cable taken along the line V-V shown in FIG. 4.

FIG. 6 is a cross-sectional view of an electrical-connector-equipped cable according to a first modification.

FIG. 7 is a cross-sectional view of an electrical-connector-equipped cable according to a second modification.

FIG. 8 is a cross-sectional view of an electrical-connector-equipped cable according to a third modification.

### DETAILED DESCRIPTION

### Problems to be Solved by the Present Disclosure

In the cable described in WO 2019/208091, since a portion of the conductor is exposed from the covering, the dielectric constant distribution of the vicinity of the conductor becomes non-uniform. As a result, there is a concern that the communication performance may be degraded due to impedance mismatching.

### Effects of the Present Disclosure

According to the present disclosure, the deterioration in the communication performance can be prevented.

### Description of Embodiments of Present Disclosure

First, contents of an embodiment of the present disclosure will be listed and described.

An electrical-connector-equipped cable of the present disclosure is [1] “an electrical-connector-equipped cable including a ferrule including a front end surface and an insertion hole opened in the front end surface, and a flat cable including a plurality of conductors arranged side by side and an insulating covering collectively covering the plurality of conductors, wherein each of the plurality of conductors includes a front end region, the front end region being inserted into the insertion hole in such a manner as to be exposed from the covering, and the ferrule includes a dielectric constant adjusting hole formed at a position in the vicinity of the insertion hole in the front end surface and is configured to adjust a dielectric constant of the vicinity of the insertion hole”.

In the electrical-connector-equipped cable according to [1], the ferrule includes the dielectric constant adjusting hole formed at a position in the vicinity of the insertion hole in the front end surface and is configured to adjust the dielectric constant of the vicinity of the insertion hole. The dielectric constant adjusting hole prevents the non-uniformity of the dielectric constant distribution in the vicinity of the conductor. Thus, the deterioration in the communication performance due to the impedance mismatch is prevented. According to the electrical-connector-equipped cable, it is possible to prevents the deterioration in the communication performance.

The electrical-connector-equipped cable of the present disclosure may be [2] “the electrical-connector-equipped cable according to [1], further including a dielectric constant adjusting agent placed inside the dielectric constant adjusting hole”. In this case, the degree of freedom of adjustment of the dielectric constant of the vicinity of the insertion hole is improved.

The electrical-connector-equipped cable of the present disclosure may be [3] “the electrical-connector-equipped cable according to [1] or [2], wherein the ferrule further includes a rear end surface facing opposite to the front end surface, and the dielectric constant adjusting hole is inclined such that it gets closer to the insertion hole as the dielectric constant adjusting hole extends from the front end surface towards the rear end surface”. In this case, the non-uniformity of the dielectric constant distribution in the vicinity of the boundary between the front end region of the conductor and a covered region of the conductor covered with the covering is certainly prevented.

The electrical-connector-equipped cable of the present disclosure may be [4] “the electrical-connector-equipped cable according to any one of [1] to [3], wherein the plurality of conductors are arranged in a first direction, and the flat cable is each of a plurality of flat cables stacked in a second direction orthogonal to the first direction”. In this case, the deterioration in the communication performance of the plurality of flat cables is prevented.

The electrical-connector-equipped cable of the present disclosure may be [5] “the electrical-connector-equipped cable according to any one of [1] to [4], wherein the flat cable is bent inside the ferrule”. In this case, the degree of freedom of arrangement of the electrical-connector-equipped cable is improved.

The electrical-connector-equipped cable of the present disclosure may be [6] “the electrical-connector-equipped cable according to any one of [1] to [5], wherein the dielectric constant adjusting hole is extend along an outer edge of the insertion hole when viewed from a direction orthogonal to the front end surface”. In this case, the dielectric constant of the vicinity of the insertion hole can be appropriately adjusted.

### Details of Embodiments of Present Disclosure

Specific examples of the electrical-connector-equipped cable of the present disclosure will be described below with reference to the drawings. The present disclosure is not limited to these examples, but is indicated by the claims, and is intended to include all modifications within the meaning and scope equivalent to the claims. In the description of the drawings, the same elements are denoted by the same reference signs, and redundant description will be omitted.

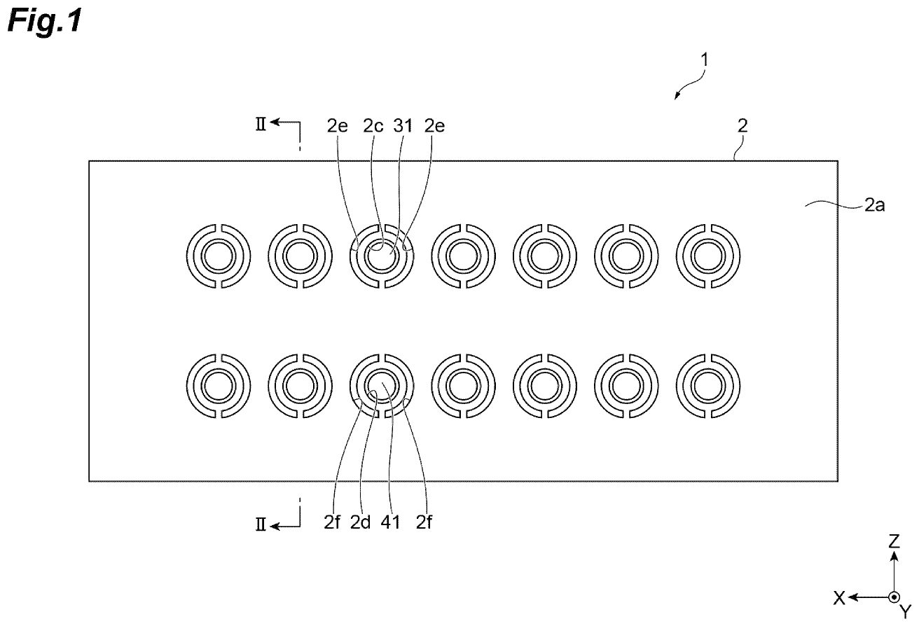

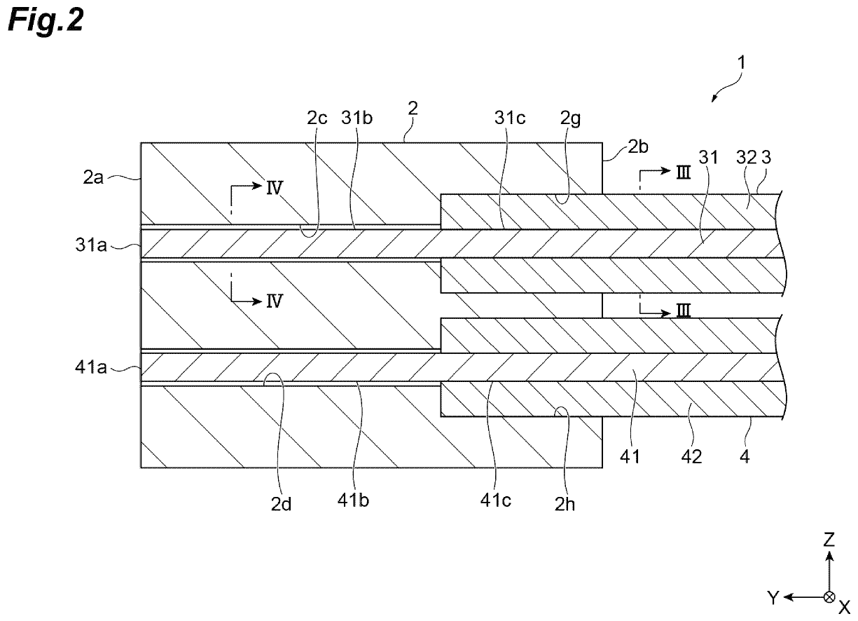

FIG. 1 is a front view of an electrical-connector-equipped cable of the embodiment. FIG. 2 is a cross-sectional view of the electrical-connector-equipped cable taken along the line II-II shown in FIG. 1. As shown in FIGS. 1 and 2, an electrical-connector-equipped cable 1 includes a ferrule 2, a first flat cable 3, and a second flat cable 4. Ferrule 2 includes a front end surface 2a and a rear end surface 2b. Each of front end surface 2a and rear end surface 2b is a flat surface intersecting with the Y-axis direction (orthogonal to the Y-axis direction in the embodiment). Rear end surface 2b faces opposite to front end surface 2a.

Ferrule 2 includes a plurality of first insertion holes 2c and a plurality of second insertion holes 2d. First insertion hole 2c extends along the Y-axis direction and opens in front end surface 2a. First insertion hole 2c has, for example, a circular shape when viewed from the Y-axis direction. The plurality of first insertion holes 2c are arranged in the X-axis direction when viewed from the Y-axis direction.

Second insertion hole 2d extends along the Y-axis direction and opens in front end surface 2a. Second insertion hole 2d has, for example, a circular shape when viewed from the Y-axis direction. The plurality of second insertion holes 2d are arranged in the X-axis direction when viewed from the Y-axis direction. The plurality of second insertion holes 2d are located adjacent to the plurality of first insertion holes 2c in the Z-axis direction when viewed from the Y-axis direction.

Ferrule 2 includes a first space 2g and a second space 2h. Each of first space 2g and second space 2h is opened in rear end surface 2b. A portion of first space 2g near the center overlaps with the plurality of first insertion holes 2c when viewed from the Y-axis direction. First space 2g is connected to each first insertion hole 2c. A portion of second space 2h near the center overlaps with the plurality of second insertion holes 2d when viewed from the Y-axis direction. Second space 2h is connected to each second insertion hole 2d.

Ferrule 2 includes a plurality of first dielectric constant adjusting holes 2e and a plurality of second dielectric constant adjusting holes 2f. First dielectric constant adjusting hole 2e is formed at a position in the vicinity of first insertion hole 2c in front end surface 2a. In the embodiment, first dielectric constant adjusting hole 2e is formed around each first insertion hole 2c. Second dielectric constant adjusting hole 2f is formed at a position in the vicinity of second insertion hole 2d in front end surface 2a. In the embodiment, second dielectric constant adjusting hole 2f is formed around each second insertion hole 2d.

Ferrule 2 contains, for example, PEI (polyetherimide), PPS (polyphenylene sulfide), PC (polycarbonate), PMMA (polymethyl methacrylate), PES (polyethersulfone), or the like as a main component.

Each of first flat cable 3 and second flat cable 4 is, for example, a flexible flat cable (FFC). Each of first flat cable 3 and second flat cable 4 has a length direction in the Y-axis direction and a width direction in the X-axis direction (first direction). First flat cable 3 and second flat cable 4 are stacked in the Z-axis direction (second direction orthogonal to the first direction).

First flat cable 3 includes a plurality of first conductors 31 arranged side by side and a first covering 32 which is an insulating covering collectively covering the plurality of first conductors 31. First conductor 31 has, for example, a fiber shape. First conductor 31 extends along the Y-axis direction. First conductor 31 has, for example, a circular shape in a cross section along the XZ plane. The plurality of first conductors 31 are arranged in the X-axis direction (first direction). The material of first conductor 31 is, for example, copper or a copper alloy. First conductor 31 functions as, for example, a signal line. At least one first conductor 31 of the plurality of first conductors 31 may function as, for example, a ground line.

First covering 32 bundles the plurality of first conductors 31. First conductor 31 includes a front end region 31b and a covered region 31c. Front end region 31b is a region of first conductor 31 that includes a front end surface 31a of first conductor 31 and is exposed from first covering 32. Covered region 31c is covered with first covering 32.

Front end region 31b of first conductor 31 is inserted into first insertion hole 2c in such a manner as to be exposed from first covering 32. Front end region 31b is inserted into first insertion hole 2c so that front end surface 31a is exposed from front end surface 2a of ferrule 2. That is, front end surface 31a of first conductor 31 is not covered by ferrule 2. Covered region 31c of first conductor 31 is disposed in first space 2g in such a manner as to be covered with first covering 32.

Second flat cable 4 includes similar configuration as first flat cable 3. That is, second flat cable 4 includes a plurality of second conductors 41 arranged side by side and a second covering 42 which is an insulating covering collectively covering the plurality of second conductors 41. Second conductor 41 has, for example, a fiber shape. Second conductor 41 extends along the Y-axis direction. Second conductor 41 has, for example, a circular shape in a cross section along the XZ plane. The plurality of second conductors 41 are arranged in the X-axis direction (first direction). The material of second conductor 41 is, for example, copper or a copper alloy. Second conductor 41 functions as, for example, a signal line. At least one second conductor 41 of the plurality of second conductors 41 may function as, for example, a ground line.

Second covering 42 bundles the plurality of second conductors 41. Second conductor 41 includes a front end region 41b and a covered region 41c. Front end region 41b is a region of second conductor 41 that includes a front end surface 41a of second conductor 41 and is exposed from second covering 42. Covered region 41c is covered with second covering 42.

Front end region 41b of second conductor 41 is inserted into second insertion hole 2d in such a manner as to be exposed from second covering 42. Front end region 41b is inserted into second insertion hole 2d so that front end surface 41a is exposed from front end surface 2a of ferrule 2. That is, front end surface 41a of second conductor 41 is not covered with ferrule 2. Covered region 41c of second conductor 41 is disposed in second space 2h in such a manner as to be covered with second covering 42.

Front end surface 31a of first conductor 31, front end surface 41a of second conductor 41, and front end surface 2a of ferrule 2 are located on substantially identical plane. The expression “substantially identical” includes not only “completely identical” but also “identical within a certain error range”. The certain error is, for example, about several micrometers. Each of front end surface 31a of first conductor 31 and front end surface 41a of second conductor 41 may protrude or recede from front end surface 2a of ferrule 2 within a range in which first conductor 31 and second conductor 41 can be electrically connected to a mating connector (receptacle). For example, in the connector-equipped cable of the present disclosure, the conductor may protrude from the ferrule surface, and the protruding portion may be accommodated in the receptacle from a receptacle front surface (in a state where a ferrule end surface and a receptacle end surface are in contact with each other), and the conductor of a connector and the conductor of the receptacle may be electrically connected to each other. Since front end surface 31a of first conductor 31 and front end surface 41a of second conductor 41 are electrically connected to the connection counterpart (a terminal or a pad provided in the connector or a base plate), no stub is generated, and the deterioration in the communication performance is prevented.

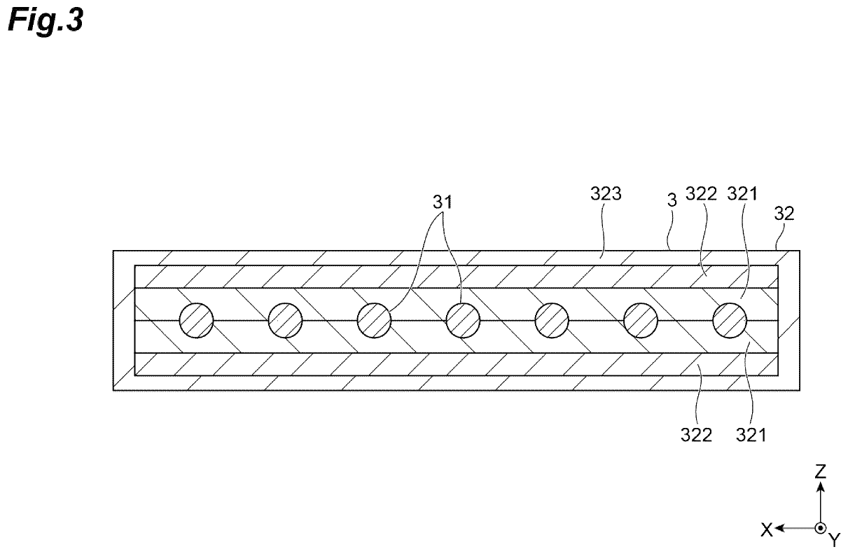

First covering 32 of first flat cable 3 will be described in detail with reference to FIG. 3. FIG. 3 is a cross-sectional view of first flat cable 3 taken along the line III-III shown in FIG. 2. Since the configuration of second covering 42 of second flat cable 4 is the same as the configuration of first covering 32 of first flat cable 3, in the embodiment, the description will be given focusing on first covering 32.

As shown in FIG. 3, first covering 32 includes a pair of insulating layers 321, a pair of shield layers 322, and a protection layer 323. The plurality of first conductors 31 are disposed between the pair of insulating layers 321. The pair of insulating layers 321 sandwich the plurality of first conductors 31 in the Z-axis direction. The material of insulating layer 321 is, for example, a resin or the like. As the material of insulating layer 321, for example, a resin having a relatively low relative dielectric constant and a relatively low dielectric loss tangent is used. The material of insulating layer 321 is, for example, polyethylene, polypropylene, or the like. The pair of insulating layers 321 are adhered to each other, for example, with an adhesive. Insulating layer 321 may have a laminated structure formed of a plurality of layers, for example.

The pair of shield layers 322 are disposed opposite to the plurality of first conductors 31 with respect to the pair of insulating layers 321. The pair of shield layers 322 sandwich the plurality of first conductors 31 and the pair of insulating layers 321 in the Z-axis direction. The material of shield layer 322 is, for example, metal or the like. The material of shield layer 322 is, for example, copper, aluminum, or the like. The thickness of shield layer 322 is, for example, equal to or greater than 5 μm and equal to or less than 20 μm. Shield layer 322 is adhered to insulating layer 321 with, for example, an adhesive.

Protection layer 323 is provided outside the pair of shield layers 322. Protection layer 323 surrounds the plurality of first conductors 31, the pair of insulating layers 321, and the pair of shield layers 322 when viewed from the Y-axis direction. Protection layer 323 covers a main surface of each of the pair of shield layers 322, side surfaces of each of the pair of shield layers 322, and side surfaces of each of the pair of insulating layers 321. Protection layer 323 prevents contact of shield layer 322 with other metal members. As the material of protection layer 323, for example, a resin or the like having excellent mechanical strength is used. The material of protection layer 323 is, for example, polyester (PEs), polyethylene terephthalate (PET), or the like. Protection layer 323 is adhered to the pair of shield layers 322 and the pair of insulating layers 321, for example, with an adhesive. The configuration of second covering 42 is the same as the configuration of first covering 32.

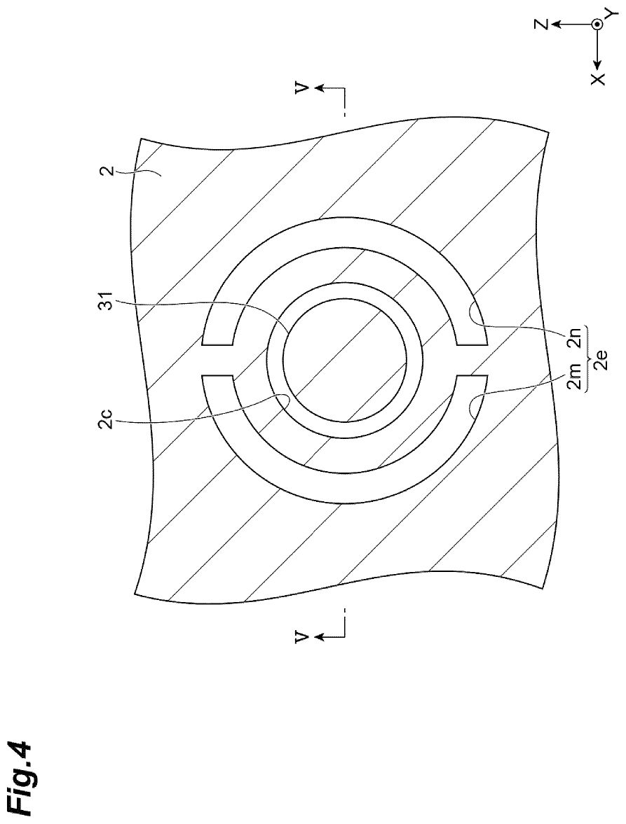

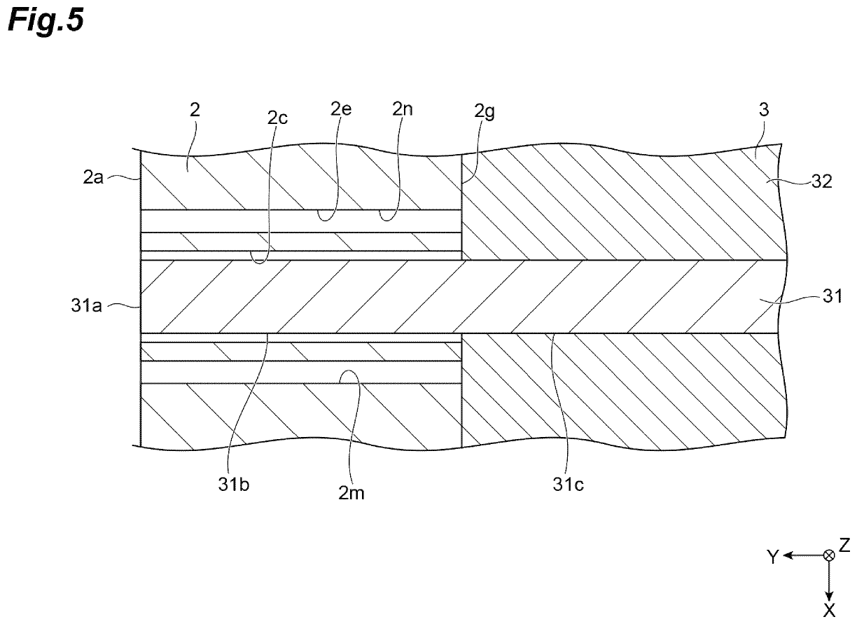

Next, first dielectric constant adjusting hole 2e will be described in detail with reference to FIGS. 4 and 5. First dielectric constant adjusting hole 2e is a hole for adjusting the dielectric constant of the vicinity of first insertion hole 2c. Since the configuration of second dielectric constant adjusting hole 2f is the same as the configuration of first dielectric constant adjusting hole 2e, in the embodiment, the description will be given focusing on first dielectric constant adjusting hole 2c. As shown in FIGS. 4 and 5, first dielectric constant adjusting hole 2e is located around first insertion hole 2c. First dielectric constant adjusting hole 2e extends along an outer edge of first insertion hole 2c and surrounds first insertion hole 2c when viewed from the Y-axis direction (direction orthogonal to front end surface 2a of ferrule 2). First dielectric constant adjusting hole 2e has, for example, a substantially annular shape when viewed from the Y-axis direction.

First dielectric constant adjusting hole 2e includes a first hole 2m and a second hole 2n. First insertion hole 2c is located between first hole 2m and second hole 2n when viewed from the Y-axis direction. Each of first hole 2m and second hole 2n has a semi-annular shape when viewed from the Y-axis direction. Each of first hole 2m and second hole 2n passes through ferrule 2 in the Y-axis direction and is connected to first space 2g.

In the embodiment, the inside of first dielectric constant adjusting hole 2e is filled with air. The relative dielectric constant of the material constituting ferrule 2 is larger than the relative dielectric constant of the material constituting first covering 32. Thus, when first dielectric constant adjusting hole 2e is not formed in ferrule 2, the relative dielectric constant of the vicinity of front end region 31b of first conductor 31 is larger than the relative dielectric constant of the vicinity of covered region 31c of first conductor 31.

In the embodiment, since first dielectric constant adjusting hole 2e filled with air is formed around first insertion hole 2c, the relative dielectric constant of the vicinity of first insertion hole 2c is smaller than that of the case where first dielectric constant adjusting hole 2e is not formed around first insertion hole 2c. The difference between the relative dielectric constant of the vicinity of covered region 31c of first conductor 31 and the relative dielectric constant of the vicinity of front end region 31b of first conductor 31 is, for example, equal to or less than 0.3.

The expression “vicinity of the insertion hole” is a predetermined region of the ferrule, and is a region in which a change in a dielectric constant may affect the communication performance of the conductor. For example, in a case where the region is a region of the ferrule away from the insertion hole and the communication performance of the conductor is affected (for example, the communication performance of the conductor is reduced) by the change in the dielectric constant of the region, the region is included in the “vicinity of the insertion hole”. For example, in a case where the region is a region of the ferrule away from the insertion hole and the communication performance of the conductor is not affected by the change in the dielectric constant of the region, the region is not included in the “vicinity of the insertion hole”. In the embodiment, the vicinity of first insertion hole 2c is a region from first insertion hole 2c to an upper surface or a lower surface of ferrule 2 when viewed from the Y-axis direction.

When front end region 31b of first conductor 31 from which first covering 32 is removed is inserted into first insertion hole 2c, a discontinuity point of the dielectric constant of the dielectric materials in the vicinity of first conductor 31 occurs at this portion. Thus, reflection of the electric signal propagating through first flat cable 3 occurs, and as a result, there is a concern about an increase in loss of the electric signal, or noise emission and the deterioration of crosstalk due to resonance. In the embodiment, since first dielectric constant adjusting hole 2e is formed in ferrule 2, the non-uniformity of the dielectric constant distribution in the vicinity of first conductor 31 is alleviated, and as a result, the above-described problem is prevented. Further, for example, in a configuration in which upper surface portions of a plurality of conductors are exposed in a tip portion of a cable, and wiring portions provided in a housing are in contact with the upper surface portions of the conductors from above, thereby electrically connecting the wirings and the conductors, portions of signals propagating through the conductors may be branched at connection points between the upper surface portions of the conductors and the wiring portions and propagate to end surfaces of the conductors. In this case, transmission loss may increase due to the influence of reflection or the like of signals on the end surfaces of the conductors. In the embodiment, front end surface 31a of first conductor 31 is exposed from front end surface 2a of ferrule 2. Thus, front end surface 31a of first conductor 31 can be electrically connected to the mating connector, and the stub is prevented as compared with the case where first conductor 31 is electrically connected to the mating connector via an electric conductor electrically connected to a side surface of front end region 31b, for example. Thus, both of the deterioration in the communication performance due to the impedance mismatch and the deterioration in the communication performance due to the stub phenomenon are prevented. Thus, according to electrical-connector-equipped cable 1, it is possible to prevent the deterioration in the communication performance.

Electrical-connector-equipped cable 1 includes first flat cable 3 and second flat cable 4.

First dielectric constant adjusting hole 2e extends along the outer edge of first insertion hole 2c when viewed from the Y-axis direction. Thus, the dielectric constant of the vicinity of first insertion hole 2c can be appropriately adjusted. Here, the expression “along an outer edge” includes not only a form in which the insertion hole is sandwiched between semi-circular arc-shaped holes (the insertion hole is surrounded by substantially arc-shaped holes), but also a form in which elliptical or linear holes are formed on the upper, lower, left, and right sides of the insertion hole.

Any of the above effects is similarly exhibited in second conductor 41 of second flat cable 4.

### Modification

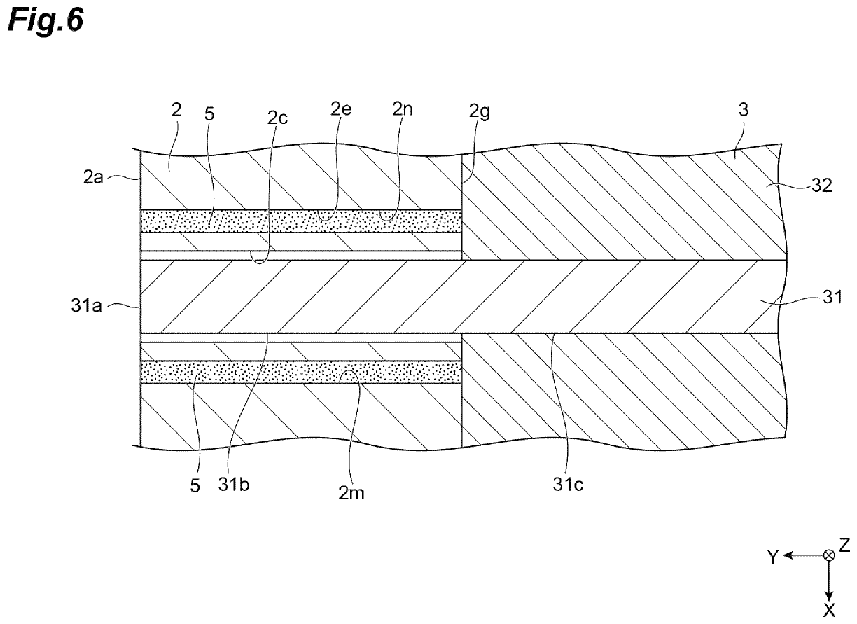

FIG. 6 is a cross-sectional view of an electrical-connector-equipped cable according to the first modification. As shown in FIG. 6, electrical-connector-equipped cable 1 may further include a dielectric constant adjusting agent 5. Dielectric constant adjusting agent 5 is placed inside first dielectric constant adjusting hole 2e. In the embodiment, dielectric constant adjusting agent 5 is filled in each of first hole 2m and second hole 2n. The relative dielectric constant of dielectric constant adjusting agent 5 is, for example, equal to or greater than about 1 and equal to or less than about 2.5. Dielectric constant adjusting agent 5 is, for example, a bleaching powder, zinc oxide, or the like. In this case, the degree of freedom of adjustment of the dielectric constant of the vicinity of first insertion hole 2c is improved. Dielectric constant adjusting agent 5 may be placed in second dielectric constant adjusting hole 2f as well as in first dielectric constant adjusting hole 2c.

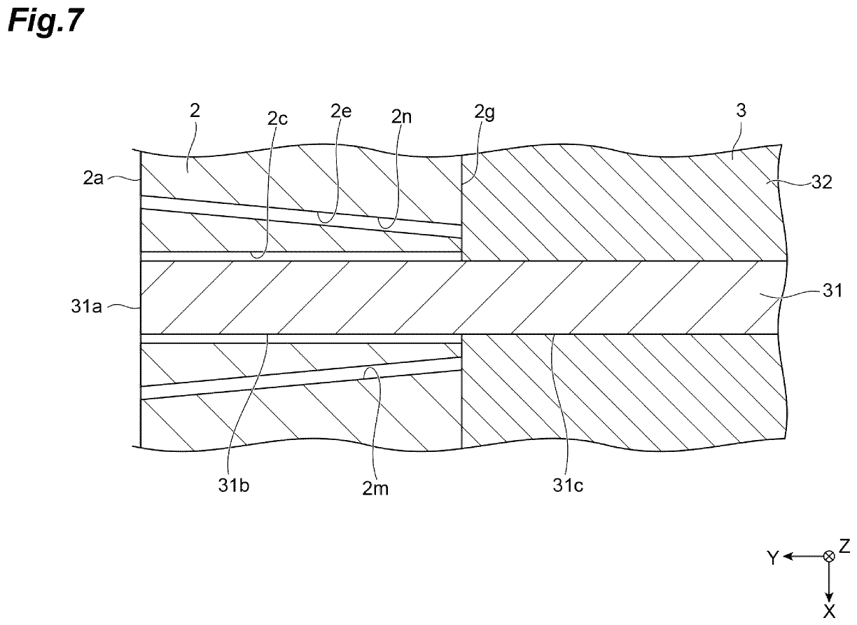

FIG. 7 is a cross-sectional view of an electrical-connector-equipped cable according to the second modification. As shown in FIG. 7, first dielectric constant adjusting hole 2e may be inclined such that it gets closer to first insertion hole 2c as first dielectric constant adjusting hole 2e extends from front end surface 2a of ferrule 2 toward rear end surface 2b (see FIG. 2). The width (inner diameter) of first dielectric constant adjusting hole 2e may be gradually reduced from front end surface 2a toward rear end surface 2b. That is, the inner diameter of first hole 2m and the inner diameter of second hole 2n may be gradually reduced from front end surface 2a toward rear end surface 2b. First dielectric constant adjusting hole 2e may have a truncated cone shape having an axis parallel to the Y-axis direction. In this case, the effect of compensating the discontinuity of the dielectric constant distribution in the vicinity of the boundary between front end region 31b of first conductor 31 and covered region 31c of first conductor 31 is large. Second dielectric constant adjusting hole 2f may also be inclined such that it gets closer to second insertion hole 2d as second dielectric constant adjusting hole 2f extends from front end surface 2a of ferrule 2 toward rear end surface 2b, similarly to first dielectric constant adjusting hole 2c.

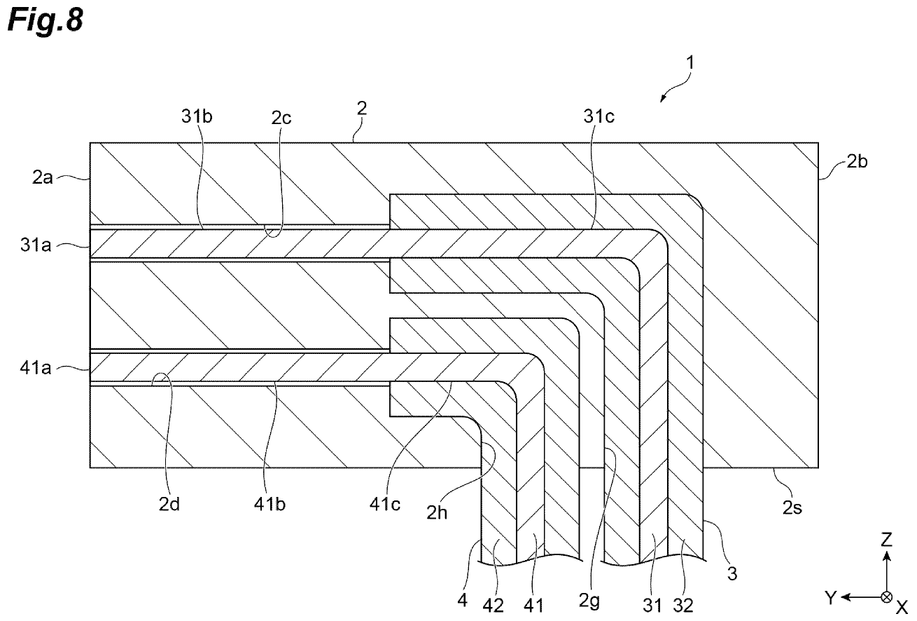

FIG. 8 is a cross-sectional view of an electrical-connector-equipped cable according to the third modification. As shown in FIG. 8, first flat cable 3 may be bent inside ferrule 2. Specifically, first space 2g of ferrule 2 is opened in a side surface 2s intersecting with the Z-axis direction (orthogonal to the Z-axis direction in FIG. 8). First space 2g includes a region extending along the Y-axis direction and a region extending along the Z-axis direction. That is, first space 2g is curved. Covered region 31c of first flat cable 3 is disposed in first space 2g in such a manner as to be bent by, for example, 90 degrees. In this case, the degree of freedom of arrangement of electrical-connector-equipped cable 1 is improved. Second flat cable 4 may also be bent inside ferrule 2, as in the case of first flat cable 3. Second space 2h may also be open in side surface 2s, similarly to first space 2g.

Electrical-connector-equipped cable 1 may include, for example, only first flat cable 3 of first flat cable 3 and second flat cable 4. In this case, ferrule 2 may not include second insertion hole 2d and second dielectric constant adjusting hole 2f. Electrical-connector-equipped cable 1 may include three or more flat cables.

First dielectric constant adjusting hole 2e may not be formed around first insertion hole 2c corresponding to first conductor 31 functioning as the ground line among the plurality of first conductors 31 of first flat cable 3. Similarly, second dielectric constant adjusting hole 2f may not be formed around second insertion hole 2d corresponding to second conductor 41 functioning as the ground line among the plurality of second conductors 41 of second flat cable 4. In the case where one first dielectric constant adjusting hole 2e is formed around of one first insertion hole 2c and one second dielectric constant adjusting hole 2f is formed around one second insertion hole 2d as in electrical-connector-equipped cable 1 according to the embodiment, the commonality of ferrule 2 can be achieved regardless of the arrangement of the conductor functioning as the signal line and the conductor functioning as the ground line among the plurality of first conductors 31 and the plurality of second conductors 41.

First dielectric constant adjusting hole 2e may not include first hole 2m or second hole 2n. First dielectric constant adjusting hole 2e may not be connected to first space 2g. The position, shape, and the like of first dielectric constant adjusting hole 2e are not particularly limited. First dielectric constant adjusting hole 2e may have, for example, a rectangular shape, a circular shape, or a long circular shape in a cross section along the XZ plane (see FIG. 4). The position, shape, and the like of second dielectric constant adjusting hole 2f are not particularly limited, as in the case of first dielectric constant adjusting hole 2e.

First covering 32 of first flat cable 3 or second covering 42 of second flat cable 4 may be integrally formed by extrusion molding using a resin, for example.

First covering 32 may be formed of a pair of resin sheets with the plurality of first conductors 31 therebetween. The pair of resin sheets may be adhered to each other. In this case, the intervals between the plurality of first conductors 31 are likely to be uniform in any cross section perpendicular to the length direction of each first conductor 31. Second covering 42 may also be formed of a pair of resin sheets with the plurality of second conductors 41 therebetween, similarly to first covering 32.

What is claimed is:

1. An electrical-connector-equipped cable comprising:
a ferrule including a front end surface and an insertion hole opened in the front end surface; and
a flat cable including a plurality of conductors arranged side by side and an insulating covering collectively covering the plurality of conductors, wherein
each of the plurality of conductors includes a front end region, the front end region being inserted into the insertion hole in such a manner as to be exposed from the covering, and
the ferrule includes a dielectric constant adjusting hole formed at a position in vicinity of the insertion hole in the front end surface and configured to adjust a dielectric constant of the vicinity of the insertion hole.

2. The electrical-connector-equipped cable according to claim 1, further comprising a dielectric constant adjusting agent placed inside the dielectric constant adjusting hole.

3. The electrical-connector-equipped cable according to claim 1, wherein
the ferrule further includes a rear end surface facing opposite to the front end surface, and
the dielectric constant adjusting hole is inclined such that it gets closer to the insertion hole as the dielectric constant adjusting hole extends from the front end surface towards the rear end surface.

4. The electrical-connector-equipped cable according to claim 1, wherein
the plurality of conductors are arranged in a first direction, and
the flat cable is each of a plurality of flat cables stacked in a second direction orthogonal to the first direction.

5. The electrical-connector-equipped cable according to claim 1, wherein the flat cable is bent inside the ferrule.

6. The electrical-connector-equipped cable according to claim 1, wherein the dielectric constant adjusting hole extends along an outer edge of the insertion hole when viewed from a direction orthogonal to the front end surface.
